(19) United States
(12) Patent Application Publication
(10) Pub. No.: US 2025/0202551 A1
(43) Pub. Date: Jun. 19, 2025

(54) BEAM SHAPE INDICATION FOR MACHINE LEARNING BASED BEAM MANAGEMENT

(71) Applicant: QUALCOMM Incorporated, San Diego, CA (US)

(72) Inventors: Qiaoyu LI, Beijing (CN); Hamed PEZESHKI, San Diego, CA (US); Sony AKKARAKARAN, Poway, CA (US); Mahmoud TAHERZADEH BOROUJENI, San Diego, CA (US); Arumugam CHENDAMARAI KANNAN, San Diego, CA (US); Jing SUN, San Diego, CA (US); Tao LUO, San Diego, CA (US); Wooseok NAM, San Diego, CA (US); Junyi LI, Greentown, PA (US); Yan ZHOU, San Diego, CA (US)

(21) Appl. No.: 18/846,199

(22) PCT Filed: Apr. 29, 2022
(86) PCT No.: PCT/CN2022/090577

§ 371 Date: Sep. 11, 2024

(51) Int. Cl. H04B 7/06; H04L 1/1607; H04L 5/00

(52) U.S. Cl. CPC H04B 7/0617; H04B 7/0695; H04L 1/1614; H04L 5/0048

(57) ABSTRACT

Certain aspects of the present disclosure provide a method for wireless communications by a user equipment (UE), generally including receiving a configuration indicating, for one or more reference signals (RSs), at least one bitmap indicating beam shape information and a reference beam direction corresponding to the bitmap, receiving dynamic signaling indicating that the UE is to update at least one of the bitmap or corresponding reference beam direction for at least one of the RSs, and updating the one of the bitmap or corresponding reference beam direction for at least one of the RSs based on the dynamic signaling.

### BACKGROUND

### Field of the Disclosure

Aspects of the present disclosure relate to wireless communications, and more particularly, to techniques for enhancing machine learning (ML) based beam management procedures.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications (e.g., by a user equipment (UE)). The method includes receiving a configuration indicating, for one or more reference signals (RSs), at least one power-per-angle value and at least one beam pointing direction value; receiving dynamic signaling indicating that the UE is to update, using at least one of the power-per-angle value or the beam pointing direction value, at least one of a beam shape associated with the one or more RSs or a beam direction associated with the one or more RSs; and updating at least one of the beam shape or the beam direction based on the dynamic signaling.

Another aspect provides a method of wireless communications by a UE. The method includes receiving a configuration indicating, for one or more RSs, at least one bitmap indicating beam shape information and a reference beam direction corresponding to the bitmap; receiving dynamic signaling indicating that the UE is to update at least one of the bitmap or corresponding reference beam direction for at least one of the RSs; and updating the one of the bitmap or corresponding reference beam direction for at least one of the RSs based on the dynamic signaling.

Another aspect provides a method of wireless communications by a network entity. The method includes transmitting a configuration indicating, for one or more RSs, at least one power-per-angle value and at least one beam pointing direction value; and transmitting dynamic signaling indicating that a UE is to update, using at least one of the power-per-angle value or the beam pointing direction value, at least one of a beam shape associated with the one or more RSs or a beam direction associated with the one or more RSs.

Another aspect provides a method of wireless communications by a network entity. The method includes transmitting a configuration indicating, for one or more RSs, at least one bitmap indicating beam shape information and a reference beam direction corresponding to the bitmap; and transmitting dynamic signaling indicating that a UE is to update at least one of the bitmap or corresponding reference beam direction for at least one of the RSs.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures, in accordance with certain aspects of the present disclosure

FIG. 6 is a diagram illustrating example operations where beam management may be performed.

FIG. 7 illustrates a general functional framework applied for AI-enabled RAN intelligence.

FIG. 8 is a diagram illustrating an example of ML based time domain beam prediction.

FIG. 9 depicts a diagram illustrating aspects of explicit SD beam prediction, in accordance with aspects of the present disclosure.

FIG. 10 depicts a diagram illustrating aspects of implicit SD beam prediction, in accordance with aspects of the present disclosure.

FIG. 11 depicts an example of radio resource control (RRC) reference signal (RS)-ID indications, in accordance with aspects of the present disclosure.

FIG. 12 depicts an example call flow diagram for providing beam shape indication for ML based beam management, in accordance with aspects of the present disclosure.

FIG. 13 depicts an example call flow diagram for providing bitmap-based beam shape indication for ML based beam management, in accordance with aspects of the present disclosure.

FIG. 14 and FIG. 15 illustrate an example of bitmap-based beam shape indication configuration, in accordance with aspects of the present disclosure.

FIG. 16 depicts a method for wireless communications.

FIG. 17 depicts a method for wireless communications.

FIG. 18 depicts a method for wireless communications.

FIG. 19 depicts a method for wireless communications.

FIG. 20 depicts aspects of an example communications device.

### DETAILED DESCRIPTION

Aspects of the present disclosure provide apparatuses, methods, processing systems, and computer-readable mediums for Bitmap Based Beam Shape Indication for ML-Based Beam Management.

Knowing beam shape information may help a UE carry out ML-based BM. For example, the beam shape information may help in reference signal received power (RSRP) or candidate beam perdition, blockage/failure prediction, or ML-based mobility procedures. Unfortunately, existing beam shape indication methods are inefficient in terms of information, resource overhead, and ability to efficiently update the information.

Aspects of the present disclosure, however, provide various techniques for signaling beam shape information that may be used in ML-based beam management procedures. In some cases, a UE may be configured with a certain set of beam shape information. The UE may then be dynamically signaled updates the information, which may provide a resource efficient way to adapt to changing conditions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

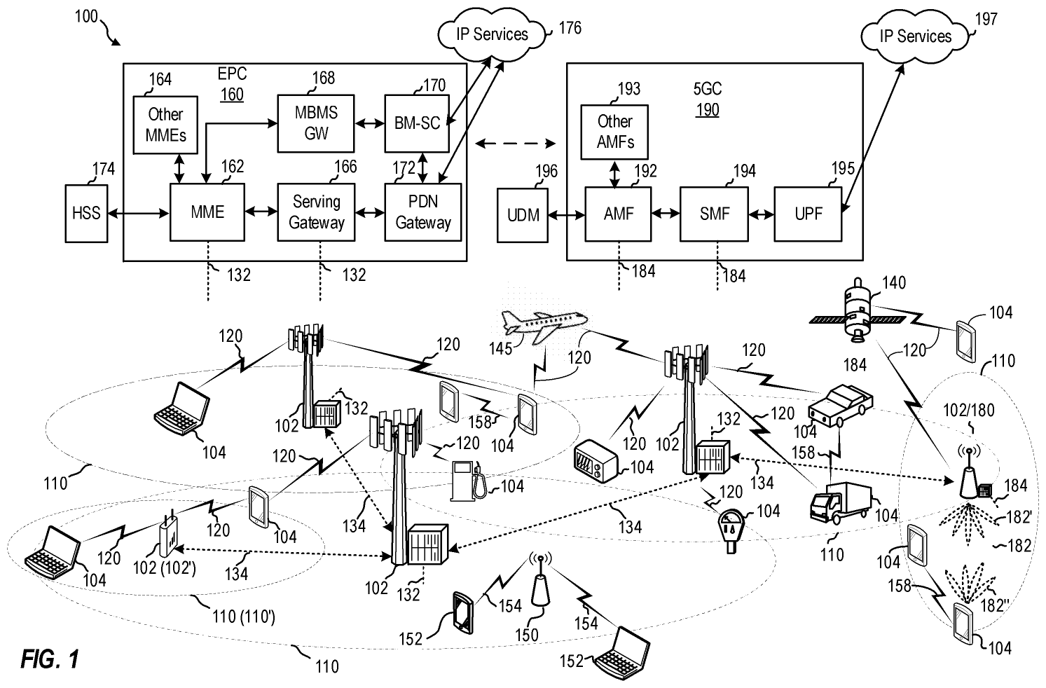

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

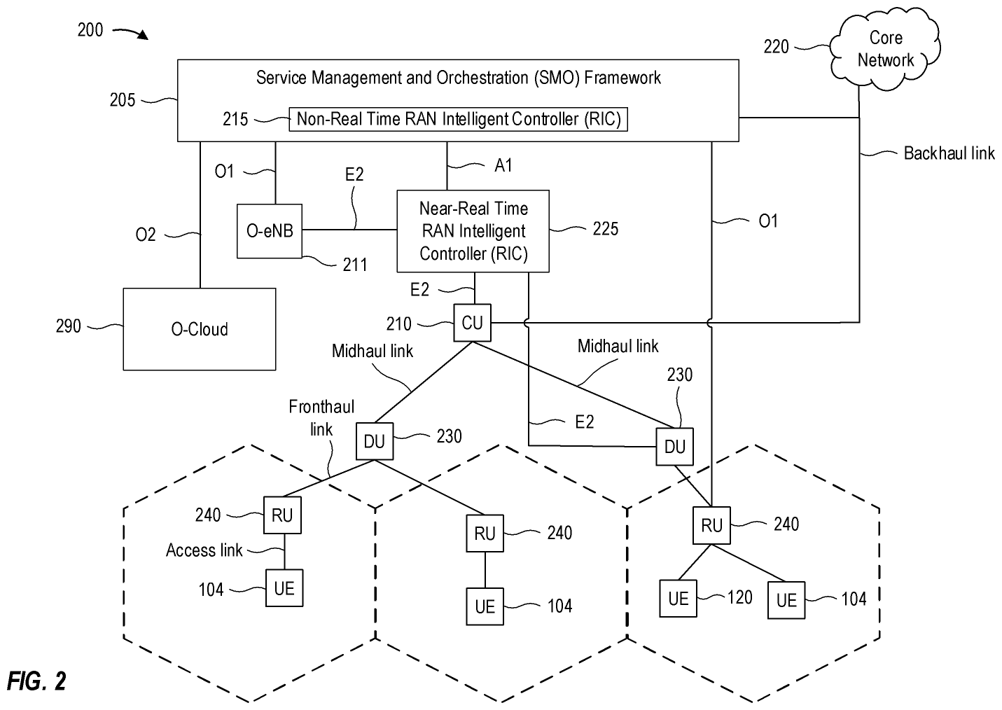

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

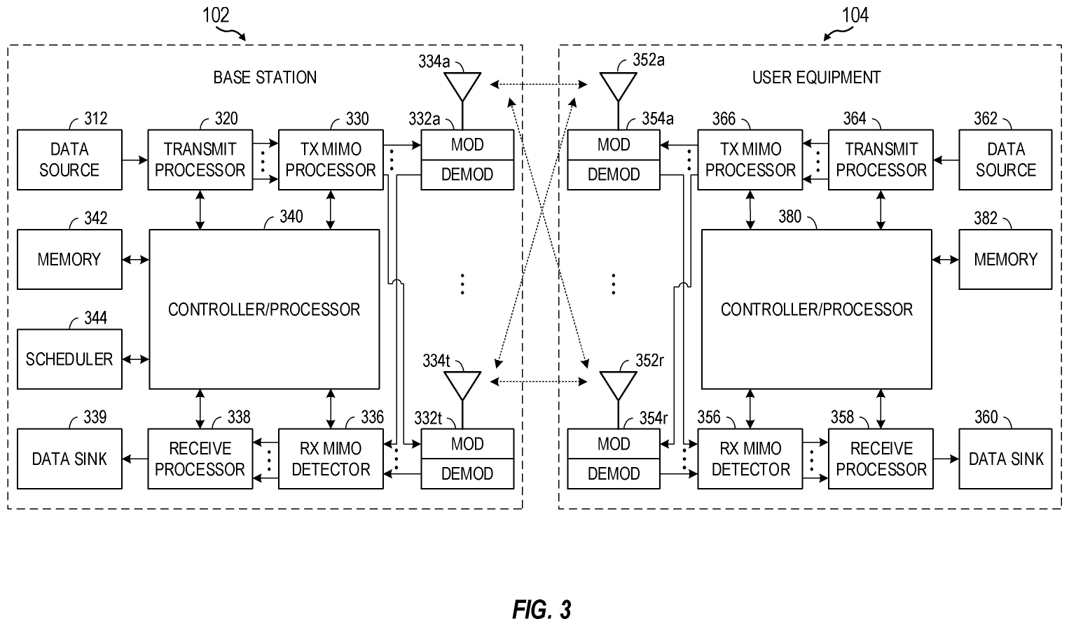

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

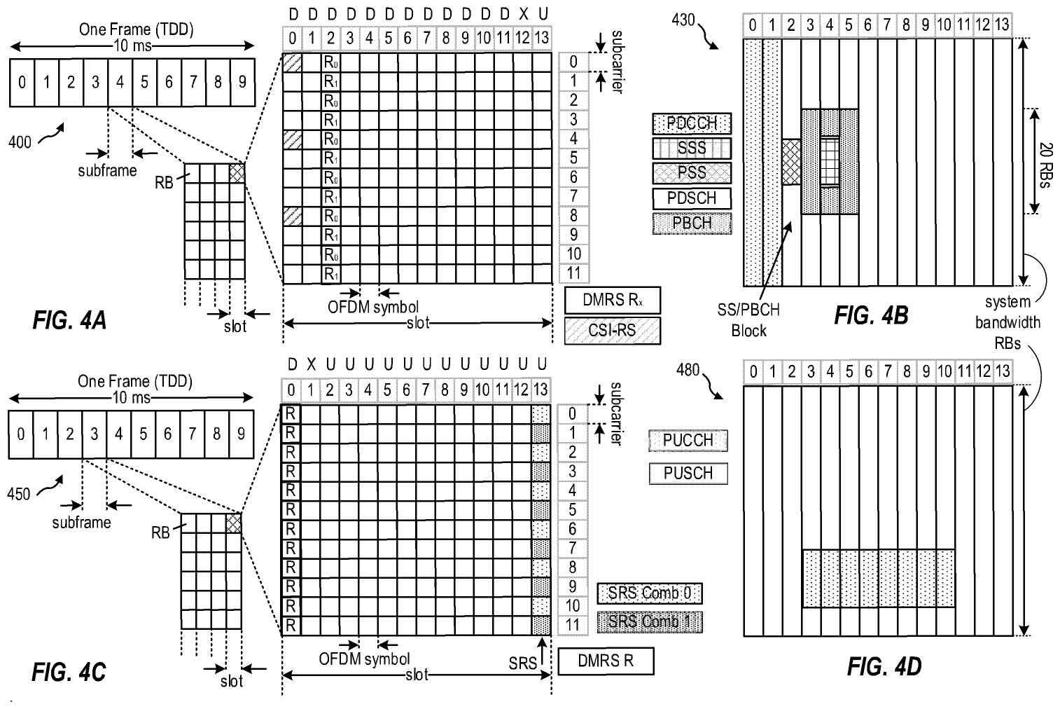

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Refinement Procedures

In mmWave systems, beam forming may be needed to overcome high path-losses. As described herein, beamforming may refer to establishing a link between a BS and UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (TRPs) or as fallback BPLs in case an existing BPL fails.

The UE typically monitors the quality of a BPL and the network may refine a BPL from time to time.

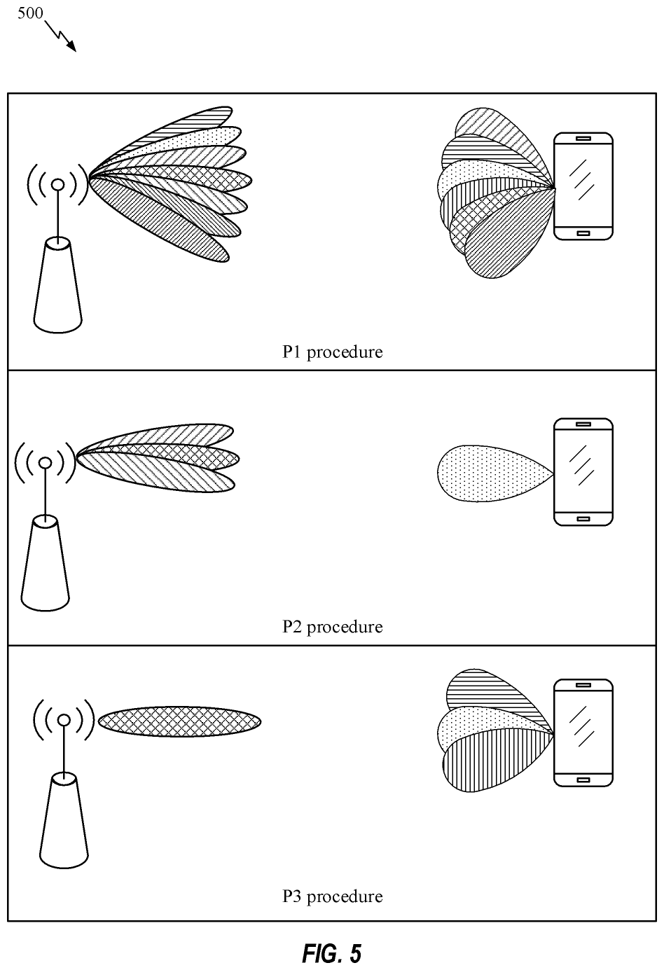

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (most, all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. The BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5). The BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Overtime, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (SRS, CSI-RS) or channel (PDSCH, PDCCH, PUSCH, PUCCH) which BPL is involved. In NR this information is called QCL indication.

Two antenna ports are QCL if properties of the channel over which a symbol on one antenna port is conveyed may be inferred from the channel over which a symbol on the other antenna port is conveyed. QCL supports, at least, beam management functionality, frequency/timing offset estimation functionality, and RRM management functionality.

The BS may use a BPL which the UE has received in the past. The transmit beam for the signal to be transmitted and the previously-received signal both point in a same direction or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI) which may be part of the PDCCH channel. Because DCI is needed to control the information, it may be desirable that the number of bits needed to indicate the QCL is not too big. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may need to evaluate several beams to obtain the best Rx beam for a given NB Tx beam. However, if the UE has to “sweep” through all of its Rx beams to perform the measurements (e.g., to determine the best Rx beam for a given NB Tx beam), the UE may incur significant delay in measurement and battery life impact. Moreover, having to sweep through all Rx beams is highly resource inefficient. Thus, aspects of the present disclosure provide techniques to assist a UE when performing measurements of serving and neighbor cells when using Rx beamforming.

### Example Beam Management

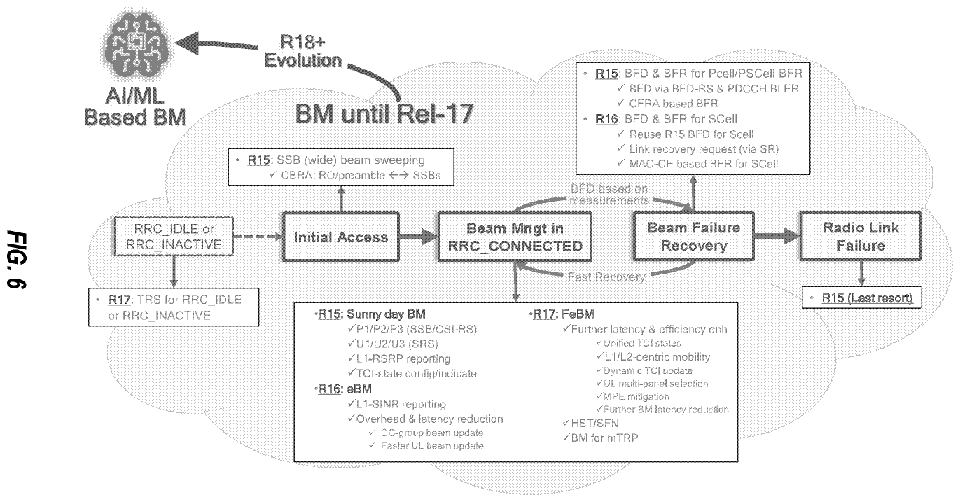

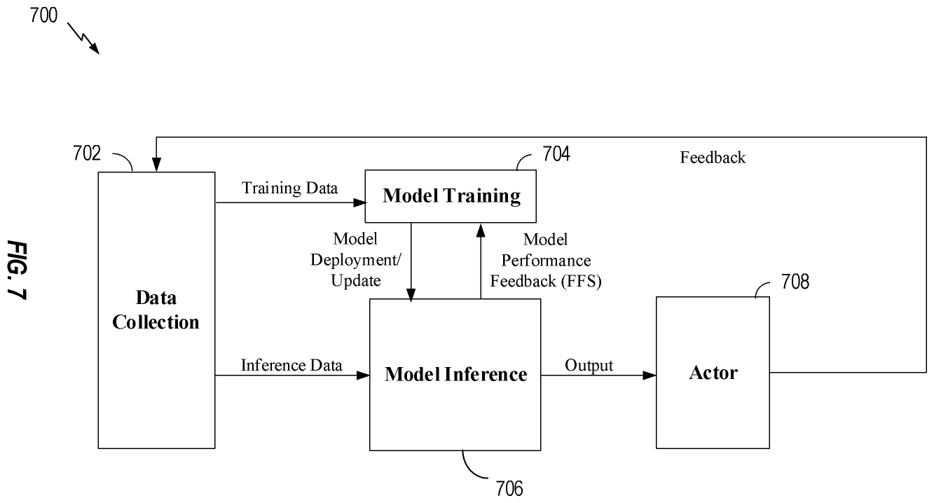

In wireless communications, various procedures may be performed for beam management. FIG. 6 is a diagram illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention CBRA procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 to recover from the radio link failure, such as a RACH procedure.

### AI/ML Functional Framework for RAN Intelligence

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the Model interface function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function is suitable for improvement of the AI/ML model trained in the model training function 704.

The model inference function 706 may signal the outputs of the model to nodes that have requested them (e.g., via subscription), or nodes that take actions based on the output from the model inference function. An AI/ML model used in a model inference function 706 may need to be initially trained, validated and tested by a model training function before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (via Data Collection function) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

### Example AI/ML Based Beam Prediction

In certain aspects, a UE or a BS may perform ML-based beam prediction using continuous measured or reported L1-RSRP in time domain. In some cases, a pre-trained deep neural network (DNN) model may be used for such ML-based predictive beam management.

Traditionally, beam qualities and failures are identified through measurement reports carried by relevant downlink (DL) and uplink (UL) reference signals (e.g., SSB, CSI-RS, RSRP), which increase beam selection latency and beam management overhead, while at the same beam selection accuracy may be limited due to restrictions on power and overhead that may cause poor system performance.

Instead, the AI/ML based predictive beam management may reduce the amount of reference signal transmissions used to predict non-measured beam qualities and future possibility of beam blockage/failure. In predictive beam management, beam prediction may be a highly non-linear problem, which may be efficiently solved by the pre-trained DNN model that may predict future beam qualities, for example, based on a UE moving speed and trajectory that is difficult to be modeled through conventional statistical processing methods.

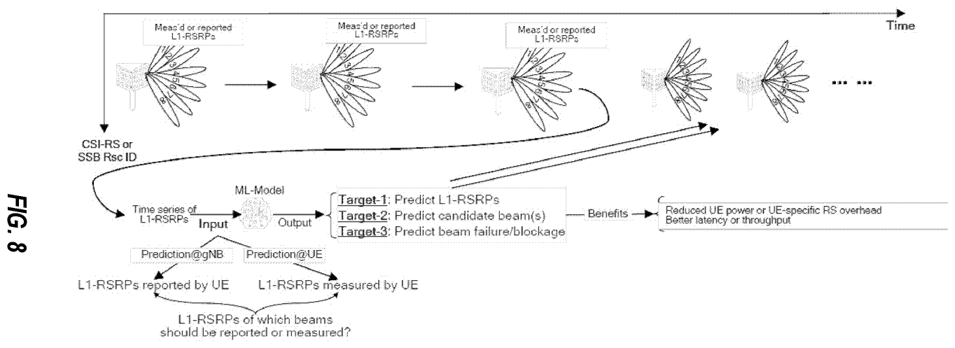

FIG. 8 is a diagram illustrating an example AI/ML based time domain beam prediction that achieves three predictive targets including: (1) future L1-RSRPs for current used beams, (2) candidate selected beams with strong power in the future, and (3) possibility of failure/blockage for current used beams.

The pre-trained DNN models with different the targets may be implemented both in the UE or the BS. A time series of L1-RSRPs may be measured by the UE and then reported to the BS as input by the pre-trained DNN models to infer future beam activities in order to enable beam prediction. The inference results compared with ground truth data as training data may be used to further train the pre-trained DNN models to improve accuracy. Without repeatedly monitoring reference signals, the AI/ML based time domain beam prediction may significantly reduce the UE power consumption and the UE-specific reference signal overhead, while at the same time improving network throughput and decreasing beam management latency.

The ML model may run at the UE or network entity (e.g., a BS such as a gNB). The data collection function noted above may be used to provide training data for the BS and the UE, in which the training data for the UE may be collected through enhanced air interface or application layer approaches, and additional the UE computation may be required by the DNN models training and necessary data storage.

AI/ML based spatial diversity (SD) beam prediction may be used for uplink or downlink beam management. ML models, deployed at the UE or gNB, for such use cases may provide explicit or implicit SD beam prediction.

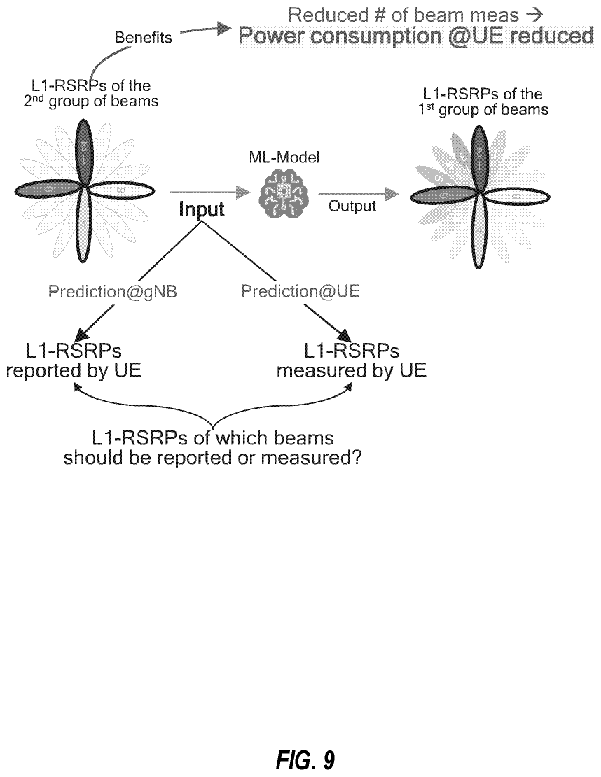

FIG. 9 illustrates an example of ML-based explicit SD beam prediction. As illustrated, explicit SD beam prediction may involve predicting L1-RSRPs of a first group of beams, based on measured/reported L1-RSRPs of a 2nd group of beams. In some cases, this type of prediction may reduce the number of beam measurements and, therefore, reduce power consumption at the UE.

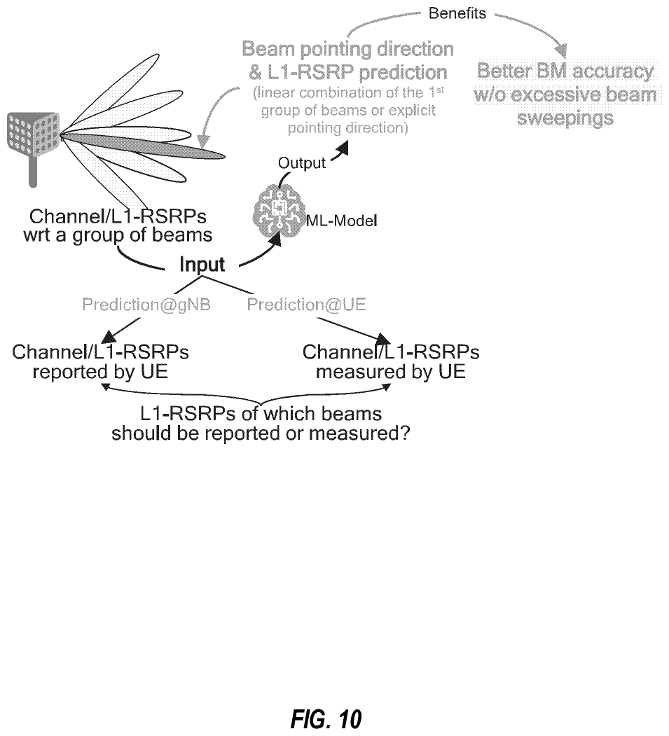

FIG. 10 illustrates an example of ML-based implicit SD beam prediction. As illustrated, implicit SD beam prediction may involve predicting beam pointing direction(s) and corresponding L1-RSRP(s), based on a linear combination of a group of beams or more explicit direction and L1-RSRP predictions. One potential benefit of this approach is that it may lead to better BM accuracy without the excessive beam sweeping of conventional BM procedures (e.g., P1, P2, and P3 of FIG. 5).

### Aspects Related to Beam Shape Indication for ML-Based Beam Management

Aspects of the present disclosure relate to wireless communications, and more particularly, to techniques for enhancing machine learning (ML) based beam management procedures.

In some cases, beam direction and/or beam shape information may be utilized to enhance ML-based beam management. In some cases, knowing the shape or pattern of beams could help a UE (or network entity) carry out ML-based BM. For example, beam shape information may help with a time domain or spatial domain (TD/SD) layer 1 (L1) reference signal receive power (L1-RSRP) or candidate beam prediction, TD beam blockage/failure prediction, AI-based L1/layer 2 (L2)-centric mobility.

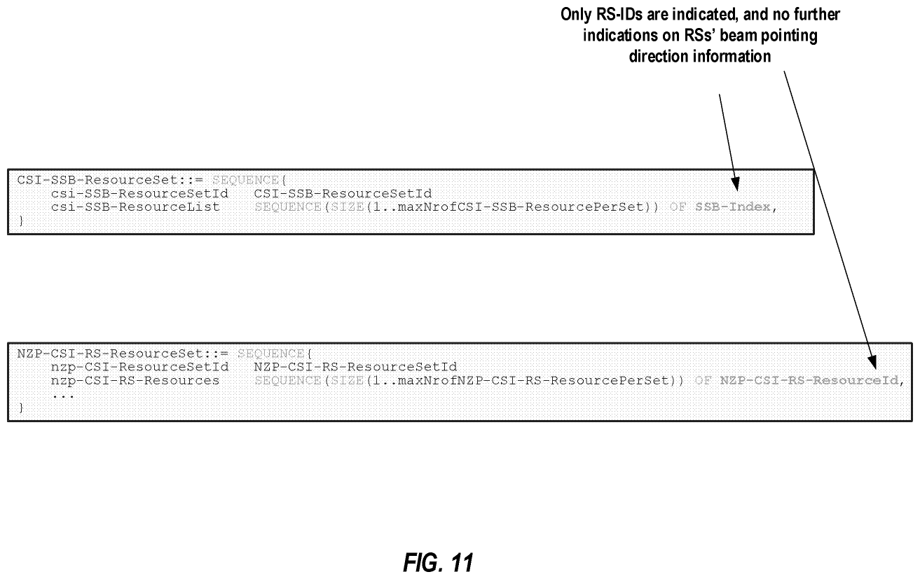

Currently, beam shape information is not provided or configured for a UE as part of CSI-RS or SSB resource set configuration. In contrast, as illustrated in FIG. 11, only RS-IDs are indicated, and there is no further indications on an RS beam pointing direction or other such information.

Existing beam shape indication methods are used in positioning use cases (e.g., in Rel-17). In such cases, a location management function (LMF) may provide a quantized version of relative power between position reference signal (PRS) resources per angle per TRP. The relative power may be defined with respect to the peak power in each angle. For each angle, at least two PRS resources may be reported, but the peak power per angle is typically not provided.

In some cases, the LMF may also provide a UE with assistance information (assist-info) on DL-PRS beam pointing direction (e.g., in both elevation and azimuth) with respect to a boresight, based on a local coordinate system (LCS) and/or a global coordinate system (GCS). There are various challenges associated with position-based beam shape indication for ML based BM. In communications use cases, a network entity (e.g., a gNB) may want to dynamically adjust the beam shape. Re-indicating the beam-shape based on conventional (positioning) methods may be less efficient when dynamic signaling is needed.

Aspects of the present disclosure provide various techniques for dynamic signaling an indication of beam shape changes. Relative to conventional approaches, the techniques may help achieve overhead reduction (e.g., using a bitmap-based beam shape indication as described below). In some cases, conventional power information may be replaced with more coarse beam-width information for overhead reduction (e.g., as accurate power information may not be as essential in communications use cases, as they might be for positioning use cases.

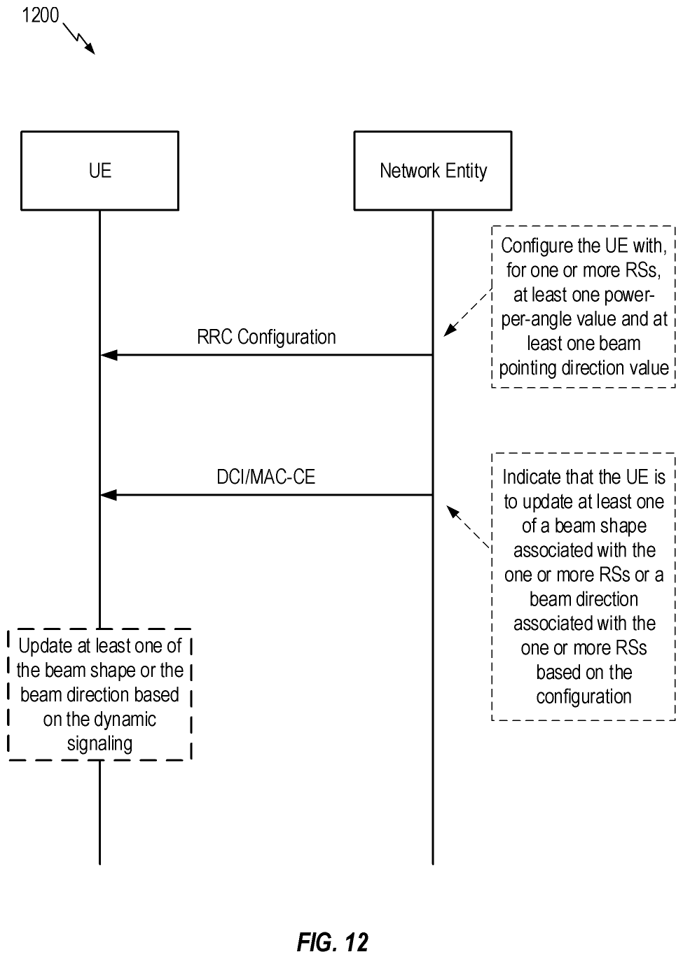

Aspects of the present disclosure for utilizing beam shape information may be understood with reference to the call flow diagram 1200 of FIG. 12. The example illustrates signaling between a network entity (e.g., a gNB or disaggregated base station component) and a UE.

As illustrated, in a first step, the UE may be radio resource control (RRC) configured (for one or more RSs) with at least one power-per-angle value and at least one beam pointing direction value. In some cases, the UE is configured with power per angle (in at least elevation and azimuth based on LCS/GCS), and beam pointing directions (in at least elevation and azimuth based on LCS/GCS for one or a group of RSs, such as channel state information reference signals (CSI-RSs) or synchronization signal blocks (SSBs).

As illustrated, in a second step, the network entity may indicate, via dynamic signaling, that the UE is to update at least one of a beam shape associated with the one or more RSs or a beam direction associated with the one or more RSs based on the configuration. For example, the indication may be provided via a media access control (MAC) control element (MAC-CE) or downlink control information (DCI), to update beam shape and/or pointing direction regarding one or more of the RSs.

There are various options for such dynamic indications to the UE. For example, according to a first option, explicit dynamic updates may be indicated to the UE. According to this option, the dynamic updates may explicitly indicate the beam shape and beam pointing direction regarding a certain RS. This option be implemented, for example, such that radio resource control (RRC) configures the UE with multiple options (e.g., sets of parameters) and the dynamic signaling (MAC-CE/DCI) may choose one of the configured options.

According to a second option, the dynamic update may indicate a differential power change with respect to a certain angle of a certain RS, for example, with reference (relative) to a previous (e.g., an originally identified) power with respect to the same angle of the same RS. Similarly, the dynamic update may indicates a differential beam pointing direction change with respect to a certain RS, referring to a previous (e.g., the originally identified) beam pointing direction with respect to the same RS. In some cases, the original identified power/angle/direction may be associated with those RRC configured, or the ones previously dynamically updated.

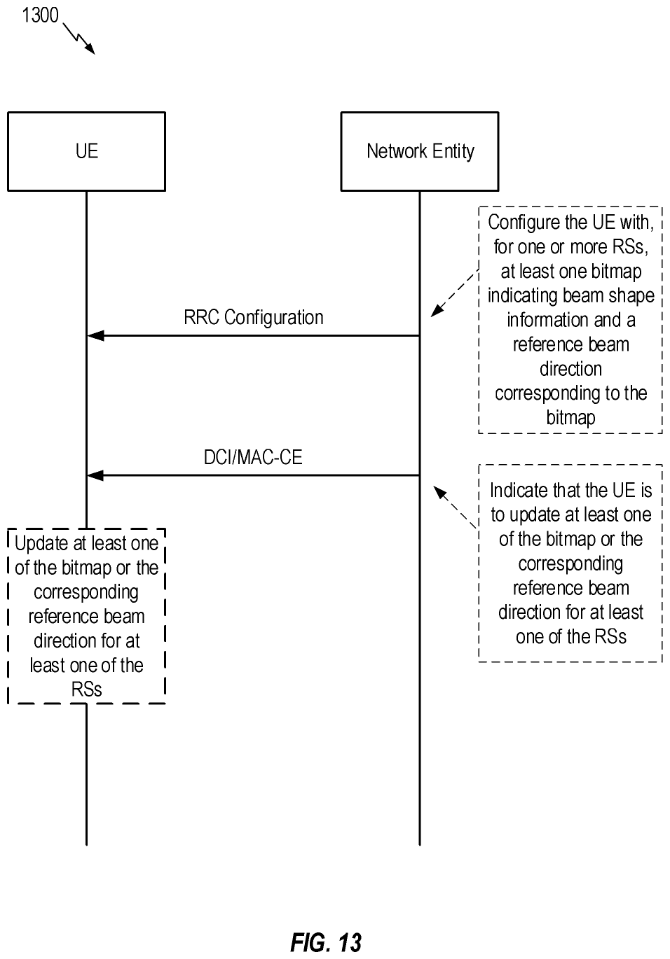

As noted above, according to certain aspects, a UE may be configured with bitmap-based beam shape information. Aspects of the present disclosure for utilizing bitmap based beam shape information may be understood with reference to the call flow diagram 1300 of FIG. 13.

As illustrated, in a first step, the UE may be RRC configured with (for one or more RSs) at least one bitmap indicating beam shape information and a reference beam direction. In some cases, the bitmap based width of the associated beam (e.g., referring to the together indicated beam pointing direction), and beam pointing directions (in at least elevation & azimuth based on LCS/GCS), and optional relative power with respect to a peak power of the angle associated with the beam pointing direction, for a group of RSs (e.g., CSI-RS or SSB) may be indicated.

As illustrated, in a second step, the network entity may indicate, via dynamic signaling (MAC-CE/DCI), that the UE is to update beam width and/or pointing direction regarding one or more of the RSs.

In some cases, the RSs are further grouped into multiple subsets, wherein RSs within the same subset are associated with the same type of bitmap, whose total number of bits, reference direction and angle difference are different from the bitmap associated with another subset. In some cases, the grouping criterion may be based on similarity of the beam pointing directions of the RSs.

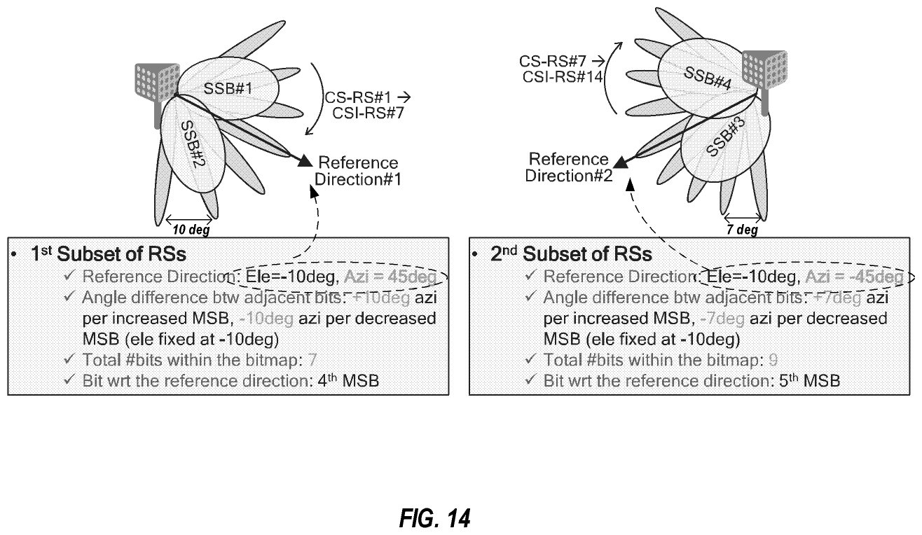

In some cases, as illustrated in FIG. 14, each bit in a bitmap may correspond to a beam and parameters for a bitmap may be configured. Such parameters may include a number of bits, reference direction, beam width, and distance (angle) between adjacent bits.

In the first example illustrated in FIG. 14, the bitmap associated with a first subset of RSs has 7 bits, a reference direction with an elevation of 10 degrees and azimuth of 45 degrees, and a width between adjacent bits of 10 degrees. One bit may be with respect to the reference direction and this bit may be the central bit. For the 7-bit bitmap example shown, this bit is the 4th most significant bit (MSB).

In the second example illustrated in FIG. 14, the bitmap associated with a second subset of RSs has 9 bits, a reference direction with an elevation of 10 degrees and azimuth of −45 degrees, and a width between adjacent bits of 7 degrees (thus it takes 8 beams to cover the same angular range as the bitmap for the 1^{st} subset of RSs with a 10 degree spacing between adjacent bits). For the 9-bit bitmap example shown, the 5^{th} MSB represents the reference direction.

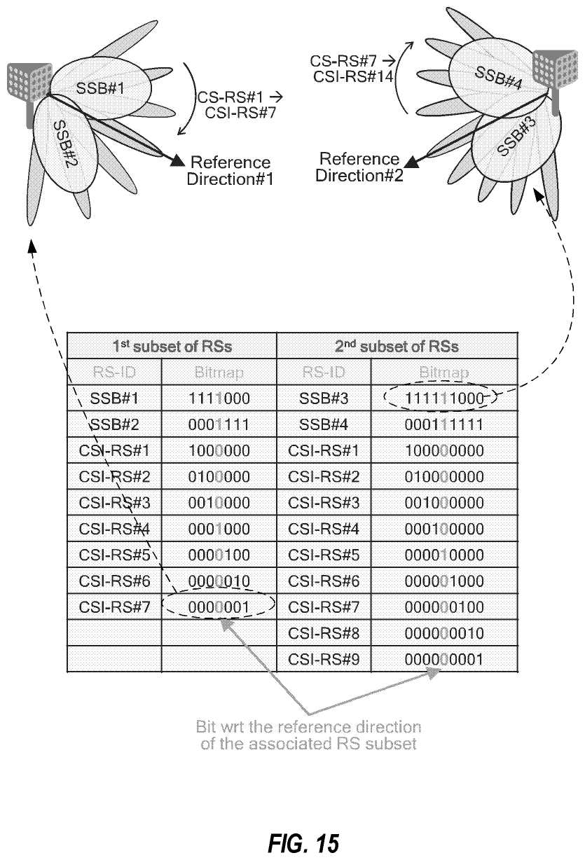

As illustrated in FIG. 15, different values of bitmaps may be associated with different RSs in a subset of RSs, with the bitmap interpretation based on the configuration shown in FIG. 14. As illsutrated, a bitmap is associated with each RS, with the aforementioned predefined central bit representing (the RRC configured) reference direction and a predefined angle difference between adjacent bits, and “1” indicating the angles within the associated (e.g., 3 dB) beam-width. The reference direction can be signaled as in (Rel. 16) positioning beam pointing direction. As illustrated, the angle difference between adjacent bits is defined along elevation/azimuth, assuming azimuth/elevation angle step-size is fixed.

In the illustrated example, the beam (shape and direction) for CSI-RS #7 (in the first subset of RSs) is defined by a bitmap “0000001” with the single “1” in the last position resulting in a relatively narrow beam width pointing in a direction 40 degrees from the reference direction. In contrast, the beam (shape and direction) for SSB #3 (in the second subset of RSs) is defined by a bitmap “111111000” with the six “1” values resulting in a much wider beam pointing to the left of the reference direction.

This bitmap-based approach may help reduce overhead, as an explicit beam pointing directions and beam shapes may not need to be signaled for every beam, as this information can be fully represented by using the reference direction together with the bitmaps. In some cases, the bitmaps can be used as ML-model inputs (e.g., wherein the ML-models can be optionally NW configured).

There are various options for dynamically updating the bitmap based beam information. According to a first option, dynamic signaling (MAC-CE/DCI) may be used to signal a differential indication, for example, by indicating a new reference direction regarding a certain RS subset (e.g., updating an RRC configured reference direction for a RS subset bitmap). According to another option, an explicit indication may be applied, for example, by indicating a new bitmap for a certain one of the RS (CSI-RS/SSB) in an RS subset.

The techniques proposed herein may be used for initial access or for connected (RRC_CONNECTED) operation. For initial access, the UE may identify the various information proposed above from system information, such as, Remaining Minimum System Information (RMSI) or Other System Information (OSI), regarding the SSBs that the gNB transmitted for initial access.

For connected mode, for a Secondary Cell Group (SCG) setup, a UE may identify the information described above, for example, from Serving Cell Configurations related with a secondary cell (Scell) for SCG setup, regarding a set of CSI-RSs/SSBs defined in the SCell.

For CSI measurement or report, the UE may identify the information proposed above, from a CSI report setting or a CSI resource setting associated with a CSI report setting, regarding a set of CSI-RSs/SSBs associated with the CSI report setting. Different aperiodic (AP) or semi-persistent (SP) triggering state configurations may comprise different beam shape/pointing information regarding the same CSI measurement resource (CMR) set, such that the triggered/activated ones can be used for dynamic altering of such information.

### Example Operations of User Equipment

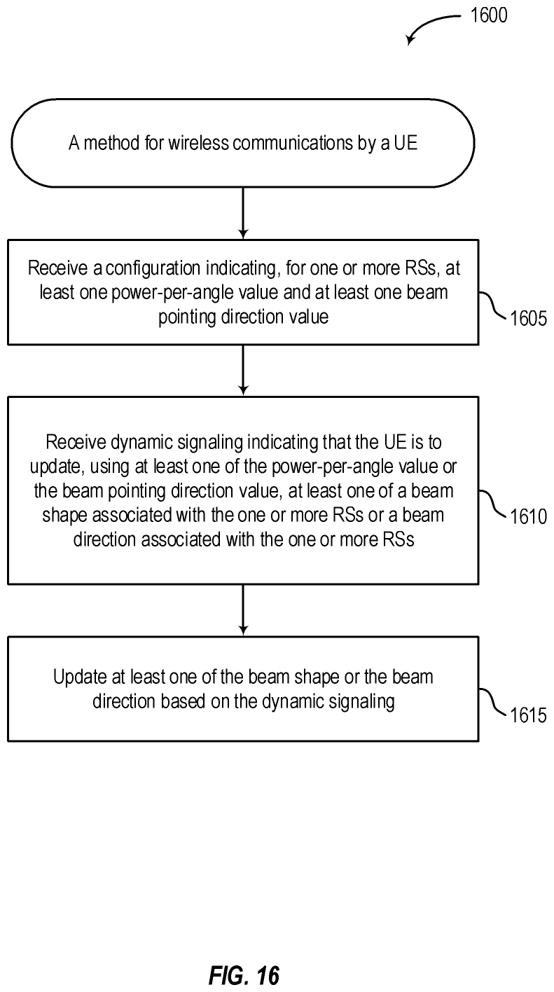

FIG. 16 shows an example of a method 1600 for wireless communications by a UE, such as UE 104 of FIGS. 1 and 3.

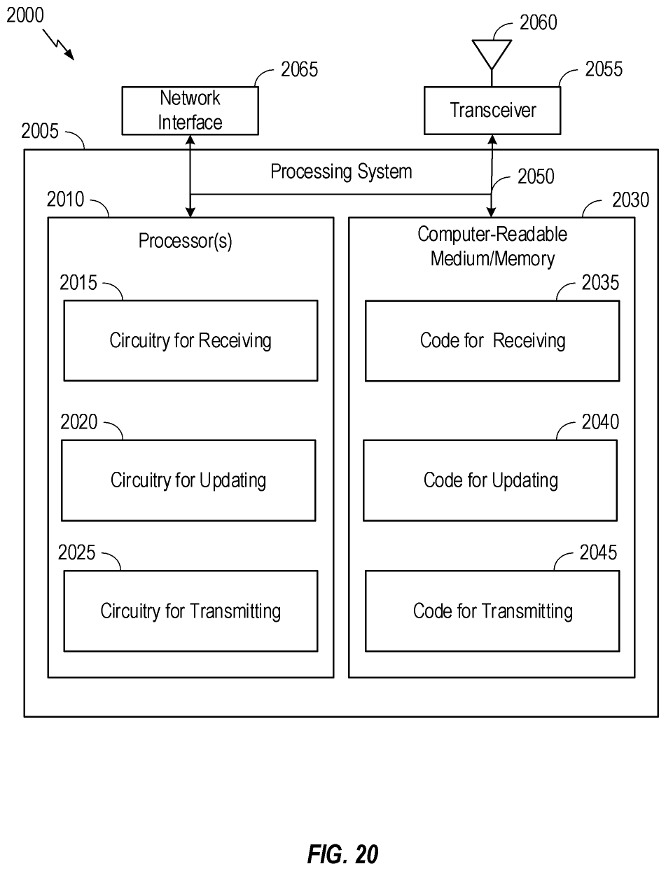

Method 1600 begins at step 1605 with receiving a configuration indicating, for one or more RSs, at least one power-per-angle value and at least one beam pointing direction value. In some cases, the operations of this step refer to, or may be performed by, circuitry for receiving and/or code for receiving as described with reference to FIG. 20.

Method 1600 then proceeds to step 1610 with receiving dynamic signaling indicating that the UE is to update, using at least one of the power-per-angle value or the beam pointing direction value, at least one of a beam shape associated with the one or more RSs or a beam direction associated with the one or more RSs. In some cases, the operations of this step refer to, or may be performed by, circuitry for receiving and/or code for receiving as described with reference to FIG. 20.

Method 1600 then proceeds to step 1615 with updating at least one of the beam shape or the beam direction based on the dynamic signaling. In some cases, the operations of this step refer to, or may be performed by, circuitry for updating and/or code for updating as described with reference to FIG. 20.

In some aspects, the one or more RSs comprise at least one of CSI-RSs or SSBs.

In some aspects, the configuration is received via RRC signaling.

In some aspects, the configuration is received via SI.

In some aspects, the configuration is received via at least one of: a serving cell configuration related to a Scell for a SCG; or a CSI report setting or a CSI resource setting associated with a CSI report setting.

In some aspects, the dynamic signaling comprises at least one of a MAC-CE or DCI signaling.

In some aspects, the beam pointing direction value, the power-per-angle value, and the beam direction are each indicated in terms of elevation and azimuth.

In some aspects, the dynamic signaling indicates a power-per-angle value and a beam pointing direction to use for the updating.

In some aspects, the configuration indicates one or more sets, each set comprising a power-per-angle value and a beam pointing direction; and the dynamic signaling indicates one of the sets for updating at least one of the beam shape or the beam direction.

In some aspects, the dynamic signaling indicates at least one of a differential power change value or a differential beam pointing direction; and the updating comprises at least one of: calculating a new power-per-angle value using the differential power change value and a previous power-per-angle value, or calculating a new beam pointing direction using the differential beam pointing direction value and a previous beam pointing direction.

In some aspects, the previous power-per-angle value comprises a RRC configured power-per-angle value or a previously dynamically updated power-per-angle value; and the previous beam pointing direction comprises an RRC configured beam pointing direction or a previously dynamically updated beam pointing direction.

In one aspect, method 1600, or any aspect related to it, may be performed by an apparatus, such as communications device 2000 of FIG. 20, which includes various components operable, configured, or adapted to perform the method 1600. Communications device 2000 is described below in further detail.

Note that FIG. 16 is just one example of a method, and other methods including fewer, additional, or alternative steps are possible consistent with this disclosure.

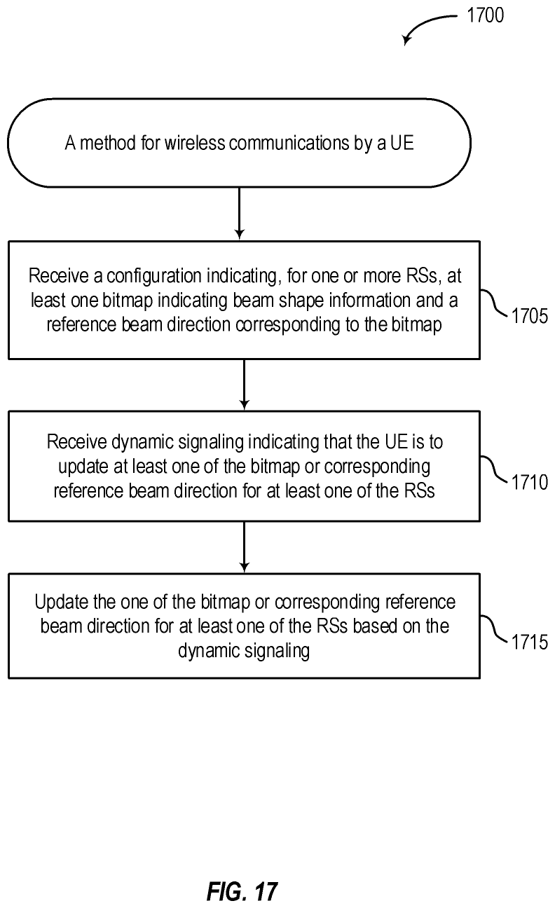

FIG. 17 shows an example of a method 1700 for wireless communications by a UE, such as UE 104 of FIGS. 1 and 3.

Method 1700 begins at step 1705 with receiving a configuration indicating, for one or more RSs, at least one bitmap indicating beam shape information and a reference beam direction corresponding to the bitmap. In some cases, the operations of this step refer to, or may be performed by, circuitry for receiving and/or code for receiving as described with reference to FIG. 20.

Method 1700 then proceeds to step 1710 with receiving dynamic signaling indicating that the UE is to update at least one of the bitmap or corresponding reference beam direction for at least one of the RSs. In some cases, the operations of this step refer to, or may be performed by, circuitry for receiving and/or code for receiving as described with reference to FIG. 20.

Method 1700 then proceeds to step 1715 with updating the one of the bitmap or corresponding reference beam direction for at least one of the RSs based on the dynamic signaling. In some cases, the operations of this step refer to, or may be performed by, circuitry for updating and/or code for updating as described with reference to FIG. 20.

In some aspects, the configuration is received via RRC signaling.

In some aspects, the configuration is received via SI.

In some aspects, the one or more RSs comprise at least one of CSI-RSs or SSBs.

In some aspects, the configuration also indicates a relative power value with respect to a peak power associated with the at least one bitmap.

In some aspects, each bit in the bitmap indicates angles within an associated beam width; and the associated beam width is predefined or configured.

In some aspects, the dynamic signaling comprises at least one of a MAC-CE or DCI signaling.

In some aspects, the at least one bitmap comprises a reference bit corresponding to the reference beam direction; and each bit in the bitmap corresponds to a beam direction and beam width.

In some aspects, the configuration indicates: an angle difference between adjacent bits; a number of bits in the bitmap; and which bit in the bitmap is the reference bit.

In some aspects, the reference beam direction and the angle difference between adjacent bits are each indicated in terms of elevation and azimuth.

In some aspects, the one or more RSs are grouped into multiple RS subsets; and RSs grouped into a same RS subset are associated with a same bitmap type.

In some aspects, bitmaps of the same bitmap type have a common reference beam direction, common angle difference between adjacent bits, common number of bits, and common reference bit.

In some aspects, the dynamic signaling indicates a new reference direction for an RS subset.

In some aspects, the dynamic signaling indicates a new bitmap for at least one of the RSs in an RS subset.

In one aspect, method 1700, or any aspect related to it, may be performed by an apparatus, such as communications device 2000 of FIG. 20, which includes various components operable, configured, or adapted to perform the method 1700. Communications device 2000 is described below in further detail.

Note that FIG. 17 is just one example of a method, and other methods including fewer, additional, or alternative steps are possible consistent with this disclosure.

### Example Operations of a Network Entity

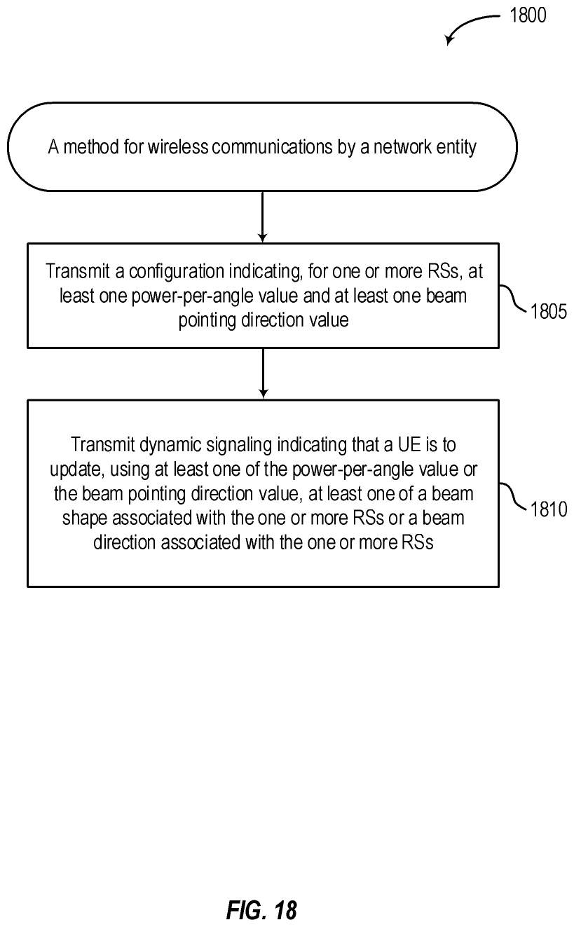

FIG. 18 shows an example of a method 1800 for wireless communications by a network entity, such as BS 102 of FIGS. 1 and 3, or a disaggregated base station as discussed with respect to FIG. 2.

Method 1800 begins at step 1805 with transmitting a configuration indicating, for one or more RSs, at least one power-per-angle value and at least one beam pointing direction value. In some cases, the operations of this step refer to, or may be performed by, circuitry for transmitting and/or code for transmitting as described with reference to FIG. 20.

Method 1800 then proceeds to step 1810 with transmitting dynamic signaling indicating that a UE is to update, using at least one of the power-per-angle value or the beam pointing direction value, at least one of a beam shape associated with the one or more RSs or a beam direction associated with the one or more RSs. In some cases, the operations of this step refer to, or may be performed by, circuitry for transmitting and/or code for transmitting as described with reference to FIG. 20.

In some aspects, the one or more RSs comprise at least one of CSI-RSs or SSBs.

In some aspects, the configuration is transmitted via RRC signaling.

In some aspects, the configuration is transmitted via SI.

In some aspects, the configuration is transmitted via at least one of: a serving cell configuration related to a Scell for a SCG; or a CSI report setting or a CSI resource setting associated with a CSI report setting.

In some aspects, the dynamic signaling comprises at least one of a MAC-CE or DCI signaling.

In some aspects, the beam pointing direction value, the power-per-angle value, and the beam direction are each indicated in terms of elevation and azimuth.

In some aspects, the dynamic signaling indicates a power-per-angle value and a beam pointing direction to use for the updating.

In some aspects, the configuration indicates one or more sets, each set comprising a power-per-angle value and a beam pointing direction; and the dynamic signaling indicates one of the sets for updating at least one of the beam shape or the beam direction.

In some aspects, the dynamic signaling indicates at least one of a differential power change value or a differential beam pointing direction; and the updating comprises at least one of: calculating a new power-per-angle value using the differential power change value and a previous power-per-angle value, or calculating a new beam pointing direction using the differential beam pointing direction value and a previous beam pointing direction.

In some aspects, the previous power-per-angle value comprises a RRC configured power-per-angle value or a previously dynamically updated power-per-angle value; and the previous beam pointing direction comprises an RRC configured beam pointing direction or a previously dynamically updated beam pointing direction.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

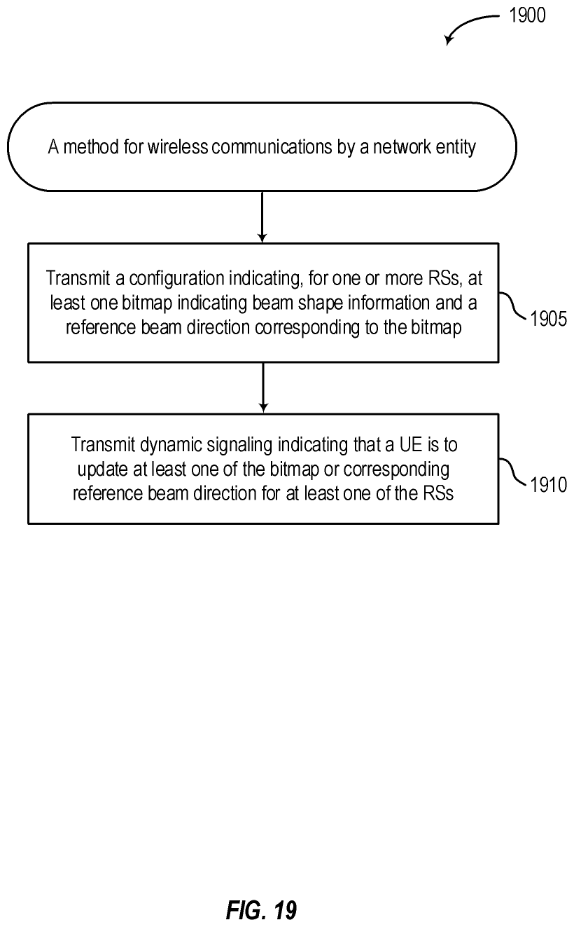

FIG. 19 shows an example of a method 1900 for wireless communications by a network entity, such as BS 102 of FIGS. 1 and 3, or a disaggregated base station as discussed with respect to FIG. 2.

Method 1900 begins at step 1905 with transmitting a configuration indicating, for one or more RSs, at least one bitmap indicating beam shape information and a reference beam direction corresponding to the bitmap. In some cases, the operations of this step refer to, or may be performed by, circuitry for transmitting and/or code for transmitting as described with reference to FIG. 20.

Method 1900 then proceeds to step 1910 with transmitting dynamic signaling indicating that a UE is to update at least one of the bitmap or corresponding reference beam direction for at least one of the RSs. In some cases, the operations of this step refer to, or may be performed by, circuitry for transmitting and/or code for transmitting as described with reference to FIG. 20.

In some aspects, the configuration is transmitted via RRC signaling.

In some aspects, the configuration is transmitted via SI.

In some aspects, the one or more RSs comprise at least one of CSI-RSs or SSBs.

In some aspects, the configuration also indicates a relative power value with respect to a peak power associated with the at least one bitmap.

In some aspects, each bit in the bitmap indicates angles within an associated beam width; and the associated beam width is predefined or configured.

In some aspects, the dynamic signaling comprises at least one of a MAC-CE or DCI signaling.

In some aspects, the at least one bitmap comprises a reference bit corresponding to the reference beam direction; and each bit in the bitmap corresponds to a beam direction and beam width.

In some aspects, the configuration indicates: an angle difference between adjacent bits; a number of bits in the bitmap; and which bit in the bitmap is the reference bit.

In some aspects, the reference beam direction and the angle difference between adjacent bits are each indicated in terms of elevation and azimuth.

In some aspects, the one or more RSs are grouped into multiple RS subsets; and RSs grouped into a same RS subset are associated with a same bitmap type.

In some aspects, bitmaps of the same bitmap type have a common reference beam direction, common angle difference between adjacent bits, common number of bits, and common reference bit.

In some aspects, the dynamic signaling indicates a new reference direction for an RS subset.

In some aspects, the dynamic signaling indicates a new bitmap for at least one of the RSs in an RS subset.

In one aspect, method 1900, or any aspect related to it, may be performed by an apparatus, such as communications device 2000 of FIG. 20, which includes various components operable, configured, or adapted to perform the method 1900. Communications device 2000 is described below in further detail.

Note that FIG. 19 is just one example of a method, and other methods including fewer, additional, or alternative steps are possible consistent with this disclosure.

### Example Communications Device

FIG. 20 depicts aspects of an example communications device 2000. In some aspects, communications device 2000 is a user equipment, such as UE 104 described above with respect to FIGS. 1 and 3. In some aspects, communications device 2000 is a network entity, such as BS 102 of FIGS. 1 and 3, or a disaggregated base station as discussed with respect to FIG. 2.

The communications device 2000 includes a processing system 2005 coupled to the transceiver 2055 (e.g., a transmitter and/or a receiver). In some aspects (e.g., when communications device 2000 is a network entity), processing system 2005 may be coupled to a network interface 2065 that is configured to obtain and send signals for the communications device 2000 via communication link(s), such as a backhaul link, midhaul link, and/or fronthaul link as described herein, such as with respect to FIG. 2. The transceiver 2055 is configured to transmit and receive signals for the communications device 2000 via the antenna 2060, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2030 via a bus 2050. In certain aspects, the computer-readable medium/memory 2030 is configured to store instructions (e.g., computer-executable code) that when executed by the one or more processors 2010, cause the one or more processors 2010 to perform: the method 1600 described with respect to FIG. 16, or any aspect related to it; the method 1700 described with respect to FIG. 17, or any aspect related to it; the method 1800 described with respect to FIG. 18, or any aspect related to it; and/or the method 1900 described with respect to FIG. 19, or any aspect related to it. Note that reference to a processor performing a function of communications device 2000 may include one or more processors 2010 performing that function of communications device 2000.

In the depicted example, computer-readable medium/memory 2030 stores code (e.g., executable instructions), such as code for receiving 2035, code for updating 2040, and code for transmitting 2045. Processing of the code for receiving 2035, code for updating 2040, and code for transmitting 2045 may cause the communications device 2000 to perform: the method 1600 described with respect to FIG. 16, or any aspect related to it; the method 1700 described with respect to FIG. 17, or any aspect related to it; the method 1800 described with respect to FIG. 18, or any aspect related to it; and/or the method 1900 described with respect to FIG. 19, or any aspect related to it.

The one or more processors 2010 include circuitry configured to implement (e.g., execute) the code stored in the computer-readable medium/memory 2030, including circuitry such as circuitry for receiving 2015, circuitry for updating 2020, and circuitry for transmitting 2025. Processing with circuitry for receiving 2015, circuitry for updating 2020, and circuitry for transmitting 2025 may cause the communications device 2000 to perform: the method 1600 described with respect to FIG. 16, or any aspect related to it; the method 1700 described with respect to FIG. 17, or any aspect related to it; the method 1800 described with respect to FIG. 18, or any aspect related to it; and/or the method 1900 described with respect to FIG. 19, or any aspect related to it.

Various components of the communications device 2000 may provide means for performing: the method 1600 described with respect to FIG. 16, or any aspect related to it; the method 1700 described with respect to FIG. 17, or any aspect related to it; the method 1800 described with respect to FIG. 18, or any aspect related to it; and/or the method 1900 described with respect to FIG. 19, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2055 and the antenna 2060 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2055 and the antenna 2060 of the communications device 2000 in FIG. 20.

### Example Clauses

Implementation examples are described in the following numbered clauses:

Clause 1: A method for wireless communications by a UE, comprising: receiving a configuration indicating, for one or more RSs, at least one power-per-angle value and at least one beam pointing direction value; receiving dynamic signaling indicating that the UE is to update, using at least one of the power-per-angle value or the beam pointing direction value, at least one of a beam shape associated with the one or more RSs or a beam direction associated with the one or more RSs; and updating at least one of the beam shape or the beam direction based on the dynamic signaling.

Clause 2: The method of Clause 1, wherein the one or more RSs comprise at least one of CSI-RSs or SSBs.

Clause 3: The method of any one of Clauses 1 and 2, wherein the configuration is received via RRC signaling.

Clause 4: The method of any one of Clauses 1-3, wherein the configuration is received via SI.

Clause 5: The method of any one of Clauses 1-4, wherein the configuration is received via at least one of: a serving cell configuration related to a Scell for a SCG; or a CSI report setting or a CSI resource setting associated with a CSI report setting.

Clause 6: The method of any one of Clauses 1-5, wherein the dynamic signaling comprises at least one of a MAC-CE or DCI signaling.

Clause 7: The method of any one of Clauses 1-6, wherein the beam pointing direction value, the power-per-angle value, and the beam direction are each indicated in terms of elevation and azimuth.

Clause 8: The method of any one of Clauses 1-7, wherein: the dynamic signaling indicates a power-per-angle value and a beam pointing direction to use for the updating.

Clause 9: The method of Clause 8, wherein: the configuration indicates one or more sets, each set comprising a power-per-angle value and a beam pointing direction; and the dynamic signaling indicates one of the sets for updating at least one of the beam shape or the beam direction.

Clause 10: The method of any one of Clauses 1-9, wherein: the dynamic signaling indicates at least one of a differential power change value or a differential beam pointing direction; and the updating comprises at least one of: calculating a new power-per-angle value using the differential power change value and a previous power-per-angle value, or calculating a new beam pointing direction using the differential beam pointing direction value and a previous beam pointing direction.

Clause 11: The method of Clause 10, wherein: the previous power-per-angle value comprises a RRC configured power-per-angle value or a previously dynamically updated power-per-angle value; and the previous beam pointing direction comprises an RRC configured beam pointing direction or a previously dynamically updated beam pointing direction.

Clause 12: A method for wireless communications by a UE, comprising: receiving a configuration indicating, for one or more RSs, at least one bitmap indicating beam shape information and a reference beam direction corresponding to the bitmap; receiving dynamic signaling indicating that the UE is to update at least one of the bitmap or corresponding reference beam direction for at least one of the RSs; and updating the one of the bitmap or corresponding reference beam direction for at least one of the RSs based on the dynamic signaling.

Clause 13: The method of Clause 12, wherein the configuration is received via RRC signaling.

Clause 14: The method of any one of Clauses 12 and 13, wherein the configuration is received via SI.

Clause 15: The method of any one of Clauses 12-14, wherein the one or more RSs comprise at least one of CSI-RSs or SSBs.

Clause 16: The method of any one of Clauses 12-15, wherein the configuration also indicates a relative power value with respect to a peak power associated with the at least one bitmap.

Clause 17: The method of any one of Clauses 12-16, wherein: each bit in the bitmap indicates angles within an associated beam width; and the associated beam width is predefined or configured.

Clause 18: The method of any one of Clauses 12-17, wherein the dynamic signaling comprises at least one of a MAC-CE or DCI signaling.

Clause 19: The method of any one of Clauses 12-18, wherein: the at least one bitmap comprises a reference bit corresponding to the reference beam direction; and each bit in the bitmap corresponds to a beam direction and beam width.

Clause 20: The method of Clause 19, wherein the configuration indicates: an angle difference between adjacent bits; a number of bits in the bitmap; and which bit in the bitmap is the reference bit.

Clause 21: The method of Clause 20, wherein the reference beam direction and the angle difference between adjacent bits are each indicated in terms of elevation and azimuth.

Clause 22: The method of Clause 20, wherein: the one or more RSs are grouped into multiple RS subsets; and RSs grouped into a same RS subset are associated with a same bitmap type.

Clause 23: The method of Clause 22, wherein bitmaps of the same bitmap type have a common reference beam direction, common angle difference between adjacent bits, common number of bits, and common reference bit.

Clause 24: The method of Clause 22, wherein the dynamic signaling indicates a new reference direction for an RS subset.

Clause 25: The method of Clause 22, wherein the dynamic signaling indicates a new bitmap for at least one of the RSs in an RS subset.

Clause 26: A method for wireless communications by a network entity, comprising: transmitting a configuration indicating, for one or more RSs, at least one power-per-angle value and at least one beam pointing direction value; and transmitting dynamic signaling indicating that a UE is to update, using at least one of the power-per-angle value or the beam pointing direction value, at least one of a beam shape associated with the one or more RSs or a beam direction associated with the one or more RSs.

Clause 27: The method of Clause 26, wherein the one or more RSs comprise at least one of CSI-RSs or SSBs.

Clause 28: The method of any one of Clauses 26 and 27, wherein the configuration is transmitted via RRC signaling.

Clause 29: The method of any one of Clauses 26-28, wherein the configuration is transmitted via SI.

Clause 30: The method of any one of Clauses 26-29, wherein the configuration is transmitted via at least one of: a serving cell configuration related to a Scell for a SCG; or a CSI report setting or a CSI resource setting associated with a CSI report setting.

Clause 31: The method of any one of Clauses 26-30, wherein the dynamic signaling comprises at least one of a MAC-CE or DCI signaling.

Clause 32: The method of any one of Clauses 26-31, wherein the beam pointing direction value, the power-per-angle value, and the beam direction are each indicated in terms of elevation and azimuth.

Clause 33: The method of any one of Clauses 26-32, wherein: the dynamic signaling indicates a power-per-angle value and a beam pointing direction to use for the updating.

Clause 34: The method of Clause 33, wherein: the configuration indicates one or more sets, each set comprising a power-per-angle value and a beam pointing direction; and the dynamic signaling indicates one of the sets for updating at least one of the beam shape or the beam direction.

Clause 35: The method of any one of Clauses 26-34, wherein: the dynamic signaling indicates at least one of a differential power change value or a differential beam pointing direction; and the updating comprises at least one of: calculating a new power-per-angle value using the differential power change value and a previous power-per-angle value, or calculating a new beam pointing direction using the differential beam pointing direction value and a previous beam pointing direction.

Clause 36: The method of Clause 35, wherein: the previous power-per-angle value comprises a RRC configured power-per-angle value or a previously dynamically updated power-per-angle value; and the previous beam pointing direction comprises an RRC configured beam pointing direction or a previously dynamically updated beam pointing direction.

Clause 37: A method for wireless communications by a network entity, comprising: transmitting a configuration indicating, for one or more RSs, at least one bitmap indicating beam shape information and a reference beam direction corresponding to the bitmap; and transmitting dynamic signaling indicating that a UE is to update at least one of the bitmap or corresponding reference beam direction for at least one of the RSs.

Clause 38: The method of Clause 37, wherein the configuration is transmitted via RRC signaling.

Clause 39: The method of any one of Clauses 37 and 38, wherein the configuration is transmitted via SI.

Clause 40: The method of any one of Clauses 37-39, wherein the one or more RSs comprise at least one of CSI-RSs or SSBs.

Clause 41: The method of any one of Clauses 37-40, wherein the configuration also indicates a relative power value with respect to a peak power associated with the at least one bitmap.

Clause 42: The method of any one of Clauses 37-41, wherein: each bit in the bitmap indicates angles within an associated beam width; and the associated beam width is predefined or configured.

Clause 43: The method of any one of Clauses 37-42, wherein the dynamic signaling comprises at least one of a MAC-CE or DCI signaling.

Clause 44: The method of any one of Clauses 37-43, wherein: the at least one bitmap comprises a reference bit corresponding to the reference beam direction; and each bit in the bitmap corresponds to a beam direction and beam width.

Clause 45: The method of Clause 44, wherein the configuration indicates: an angle difference between adjacent bits; a number of bits in the bitmap; and which bit in the bitmap is the reference bit.

Clause 46: The method of Clause 45, wherein the reference beam direction and the angle difference between adjacent bits are each indicated in terms of elevation and azimuth.

Clause 47: The method of Clause 45, wherein: the one or more RSs are grouped into multiple RS subsets; and RSs grouped into a same RS subset are associated with a same bitmap type.

Clause 48: The method of Clause 47, wherein bitmaps of the same bitmap type have a common reference beam direction, common angle difference between adjacent bits, common number of bits, and common reference bit.

Clause 49: The method of Clause 47, wherein the dynamic signaling indicates a new reference direction for an RS subset.

Clause 50: The method of Clause 47, wherein the dynamic signaling indicates a new bitmap for at least one of the RSs in an RS subset.

Clause 51: An apparatus, comprising: a memory comprising executable instructions; and a processor configured to execute the executable instructions and cause the apparatus to perform a method in accordance with any one of Clauses 1-50.

Clause 52: An apparatus, comprising means for performing a method in accordance with any one of Clauses 1-50.

Clause 53: A non-transitory computer-readable medium comprising executable instructions that, when executed by a processor of an apparatus, cause the apparatus to perform a method in accordance with any one of Clauses 1-50.

Clause 54: A computer program product embodied on a computer-readable storage medium comprising code for performing a method in accordance with any one of Clauses 1-50.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1-11. (canceled)

12. A method for wireless communications by a user equipment (UE), comprising:
receiving a configuration indicating, for one or more reference signals (RSs), at least one bitmap indicating beam shape information and a reference beam direction corresponding to the bitmap;
receiving dynamic signaling indicating that the UE is to update at least one of the bitmap or corresponding reference beam direction for at least one of the RSs; and
updating the one of the bitmap or corresponding reference beam direction for at least one of the RSs based on the dynamic signaling.

13. The method of claim 12, wherein the configuration is received via radio resource control (RRC) signaling.

14. The method of claim 12, wherein the configuration is received via system information (SI).

15. The method of claim 12, wherein the one or more RSs comprise at least one of CSI-RSs or SSBs.

16. The method of claim 12, wherein the configuration also indicates a relative power value with respect to a peak power associated with the at least one bitmap.

17. The method of claim 12, wherein:
each bit in the bitmap indicates angles within an associated beam width; and
the associated beam width is predefined or configured.

18. The method of claim 12, wherein the dynamic signaling comprises at least one of a media access control (MAC) control element (MAC-CE) or downlink control information (DCI) signaling.

19. The method of claim 12, wherein:
the at least one bitmap comprises a reference bit corresponding to the reference beam direction; and
each bit in the bitmap corresponds to a beam direction and beam width.

20. The method of claim 19, wherein the configuration indicates:
an angle difference between adjacent bits;
a number of bits in the bitmap; and
which bit in the bitmap is the reference bit.

21. The method of claim 20, wherein the reference beam direction and the angle difference between adjacent bits are each indicated in terms of elevation and azimuth.

22. The method of claim 20, wherein:
the one or more RSs are grouped into multiple RS subsets; and
RSs grouped into a same RS subset are associated with a same bitmap type.

23. The method of claim 22, wherein bitmaps of the same bitmap type have a common reference beam direction, common angle difference between adjacent bits, common number of bits, and common reference bit.

24. The method of claim 22, wherein the dynamic signaling indicates a new reference direction for an RS subset.

25. The method of claim 22, wherein the dynamic signaling indicates a new bitmap for at least one of the RSs in an RS subset.

26-36. (canceled)

37. A method for wireless communications by a network entity, comprising:
transmitting a configuration indicating, for one or more reference signals (RSs), at least one bitmap indicating beam shape information and a reference beam direction corresponding to the bitmap; and
transmitting dynamic signaling indicating that a user equipment (UE) is to update at least one of the bitmap or corresponding reference beam direction for at least one of the RSs.

38-43. (canceled)

44. The method of claim 37, wherein:
the at least one bitmap comprises a reference bit corresponding to the reference beam direction; and
each bit in the bitmap corresponds to a beam direction and beam width.

45. The method of claim 44, wherein the configuration indicates:
an angle difference between adjacent bits;
a number of bits in the bitmap; and
which bit in the bitmap is the reference bit.

46. The method of claim 45, wherein the reference beam direction and the angle difference between adjacent bits are each indicated in terms of elevation and azimuth.

47-54. (canceled)

55. A method for wireless communications by a user equipment (UE), comprising:
receiving a configuration indicating, for one or more reference signals (RSs), at least one power-per-angle value and at least one beam pointing direction value;
receiving dynamic signaling indicating that the UE is to update, using at least one of the power-per-angle value or the beam pointing direction value, at least one of a beam shape associated with the one or more RSs or a beam direction associated with the one or more RSs; and
updating at least one of the beam shape or the beam direction based on the dynamic signaling.

56. The method of claim 55, wherein the one or more RSs comprise at least one of CSI-RSs or SSBs.

57. The method of claim 55, wherein the configuration is received via radio resource control (RRC) signaling.

58. The method of claim 55, wherein the configuration is received via system information (SI).

59. The method of claim 55, wherein the configuration is received via at least one of:
a serving cell configuration related to a secondary cell (Scell) for a secondary cell group (SCG); or
a channel state information (CSI) report setting or a CSI resource setting associated with a CSI report setting.

60. The method of claim 55, wherein the dynamic signaling comprises at least one of a media access control (MAC) control element (MAC-CE) or downlink control information (DCI) signaling.

61. The method of claim 55, wherein the beam pointing direction value, the power-per-angle value, and the beam direction are each indicated in terms of elevation and azimuth.

62. The method of claim 55, wherein:
the dynamic signaling indicates a power-per-angle value and a beam pointing direction to use for the updating.

63. The method of claim 62, wherein:
the configuration indicates one or more sets, each set comprising a power-per-angle value and a beam pointing direction; and
the dynamic signaling indicates one of the sets for updating at least one of the beam shape or the beam direction.

64. The method of claim 55, wherein:
the dynamic signaling indicates at least one of a differential power change value or a differential beam pointing direction; and
the updating comprises at least one of
calculating a new power-per-angle value using the differential power change value and a previous power-per-angle value, or
calculating a new beam pointing direction using the differential beam pointing direction value and a previous beam pointing direction.

65. The method of claim 64, wherein:
the previous power-per-angle value comprises a radio resource control (RRC) configured power-per-angle value or a previously dynamically updated power-per-angle value; and
the previous beam pointing direction comprises an RRC configured beam pointing direction or a previously dynamically updated beam pointing direction.

66. A method for wireless communications by a network entity, comprising:
transmitting a configuration indicating, for one or more reference signals (RSs), at least one power-per-angle value and at least one beam pointing direction value; and
transmitting dynamic signaling indicating that a user equipment (UE) is to update, using at least one of the power-per-angle value or the beam pointing direction value, at least one of a beam shape associated with the one or more RSs or a beam direction associated with the one or more RSs.
